(19) United States
(12) Patent Application Publication
(10) Pub. No.: US 2003/0211819 A1
(43) Pub. Date: Nov. 13, 2003

(54) System for making encased sausages

(76) Inventors: Ad J. M. Bontje, Hilversum (NL); David Hamblin, Norwalk, IA (US); Steven P. Hergott, West Des Moines, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 10/311,160

(22) PCT Filed: May 10, 2002
(86) PCT No.: PCT/US02/14791

(51) Int. Cl. A22C 11/00

(52) U.S. Cl. 452/31

(57) ABSTRACT

A system for making encased sausages includes first and second sausage encasing machines. Parallel spaced encasing machines have a first space therebetween, and each being connected to a single meat emulsion supply pump located upstream therefrom. A first conduit extends from the pump, with second conduits extending from the first conduit to the respective encasing machines, whereby meat emulsion can be simultaneously pumped to the machines. First and second parallel conveyors in spaced condition create a second space therebetween and are located downstream from the first and second encasing machines respectively, with the second space being coextensive with the first space to permit a work station for an operator to remove encased sausages from both of the conveyors.

### CROSS REFERENCE TO A RELATED APPLICATION

This application is based upon Applicant's Provisional Application Serial No. 60/290,873 filed May 14, 2001.

### BACKGROUND OF THE INVENTION

Heretofore some efficiencies in linking sausages by the use of two parallel positioned sausage making machines have been attempted. See, for example, U.S. Pat. No. 5,993,307. However, the system disclosed in the foregoing patent still requires the use of two separate sausage encasing machines each having a separate supply pump for sausage emulsion. Efforts have also been made to use two sausage making machines with a single meat emulsion supply pump, but this arrangement still does not make it easy to eliminate the total number of operators. Particularly in the situation where natural casings are involved, the prior art arrangements require two machine operators for such machine plus two persons (or robots) to “stick off” the linked sausages from the conveyors located downstream from each of the machines.

Therefore, it is a principal object of this invention to provide a sausage making system comprising a single source of meat emulsion for two or more sausage making machines having parallel conveyors which will require at most only two machine operators for each machine and a single stick off operator (or robot) to remove the sausage from the conveyor.

A further object of this invention is to provide the system described heretofore wherein the supply of pressurized sausage is fully equalized.

These and other objects will be apparent to those skilled in the art.

### SUMMARY OF THE INVENTION

A system for making encased sausages includes

first and second sausage encasing machines. Parallel spaced encasing machines have a first space therebetween, and each being connected to a single meat emulsion supply pump located upstream therefrom. A first conduit extends from the pump, with second conduits extending from the first conduit to the respective encasing machines, whereby meat emulsion can be simultaneously pumped to the machines. First and second parallel conveyors in spaced condition create a second space therebetween and are located downstream from the first and second encasing machines respectively, with the second space being coextensive with the first space to permit a work station for an operator to remove encased sausages from both of the conveyors.

### BRIEF DESCRIPTION OF THE DRAWINGS

FIG. 1A is a partial side elevation of one of the prior art systems described heretofore;

FIG. 1B is a plan view of one of the prior art systems described heretofore;

FIG. 2 is a plan view of the system of this machine;

FIG. 3 is a plan view of an alternate form of this invention;

FIGS. 4A and 4B are a side view and an end view, respectively, of the single source of meat emulsion for the systems of FIGS. 2 and 3;

FIG. 5 is a partial sectional view at an enlarged scale showing a pneumatic means for equalizing and stabilizing the pressure of the meat emulsion exiting the single source of meat emulsion; and

FIG. 6 is a sectional view taken on lines 6-6 of FIG. 5.

### DESCRIPTION OF THE PREFERRED EMBODIMENT

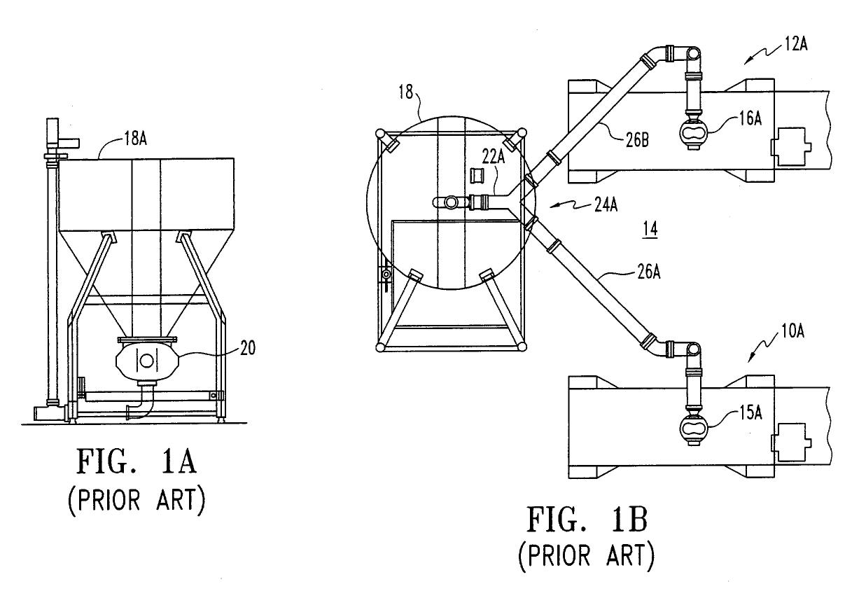

FIGS. 1A and 1B are a composite end view and plan view, respectively, of a prior art sausage encasing machine system which will be discussed hereafter.

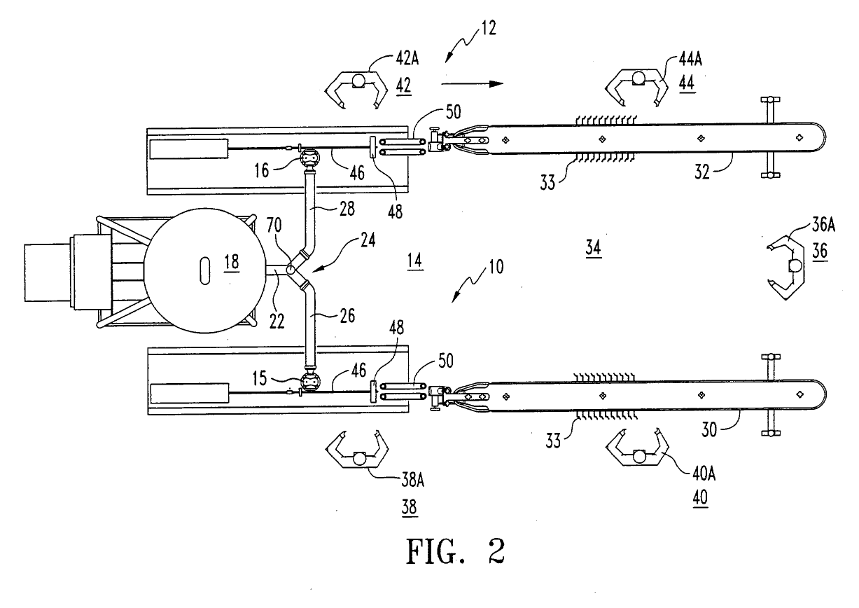

With reference to FIG. 2, sausage encasing machines 10 and 12 are conventional in construction and have an elongated shape with their center axes being parallel, and with the machines spaced apart to create an operating space 14. Each sausage machine 10 and 12 has a meat emulsion metering device 15 and 16, respectively. The system can be adapted to installations of more than 2 machines.

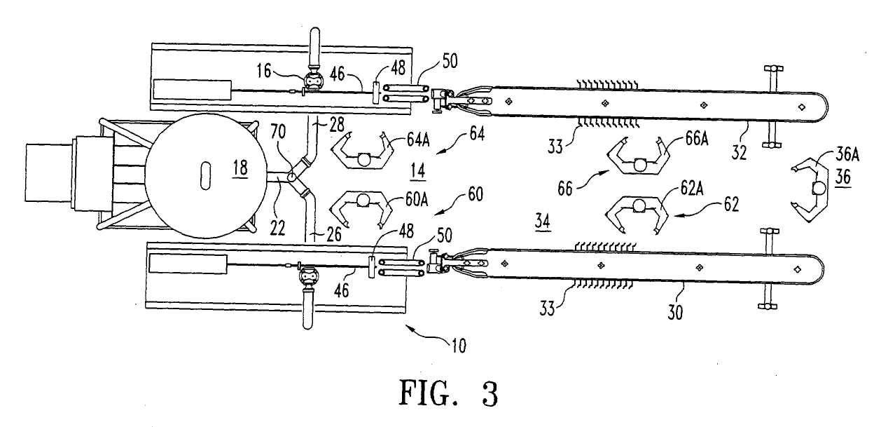

A conventional meat emulsion supply pump 20 with associated hopper 18 is located in the space 14. A first conduit 22 (FIGS. 2 and 3) extends away from the pump and terminates in a Y-connection 24 to which second conduits 26 and 28 are secured and dwell at an angle of 90 degrees with respect to the first conduit 22. Second conduits 26 and 28 connect the first conduit 22 to the metering devices 15 and 16.

As shown in FIG. 2, a first horizontal conveyor 30 is located downstream of machine 10, and a similar horizontal conveyor 32 is located downstream of the machine 12. Each of the conveyors 30 and 32 have a continuous chain, which supports a plurality of spaced hooks 33 which are adapted to receive loops of an encased elongated sausage strand. Only a portion of the hooks 33 are shown in the drawings. A second operating space 34 is located between the conveyors 30 and 32.

With reference to FIG. 2, a work station 36 is created between the conveyors 30 and 32 within the space 34, and an operator 36A is located at work station 36 so he can move to either of the conveyors to stick off finite portions of an encased sausage strand hanging from the hooks 33. The operator 36A is typically able to remove sausages from either conveyor while they are operating conventionally without getting behind. Conventional robots can be used in lieu of the operators 36A in FIGS. 2 and 3.

Again with reference to FIG. 2, work stations 38 and 42 are located on the outer sides of machines 10 and 12 and provide a working space for operators 38A and 42A, respectively, who tend to the operation of the machines 10 and 12, respectively. When natural casings are used, the operators 38A and 42A manually place the natural casings into position to be filled with meat emulsion from the metering device on machines 10 and 12, respectively. Similarly, work stations 40 and 44 are located on the outer sides of conveyors 30 and 32 to create an operating space for operators 40A and 44A, respectively. These operators serve to tie off the ends of sausage strands to prevent the encased sausage from moving outwardly therefrom.

Again with reference to FIG. 2, the numeral 46 designates a conventional stuffing tube terminating adjacent twisters 48 which are located immediately upstream of conventional linkers 50.

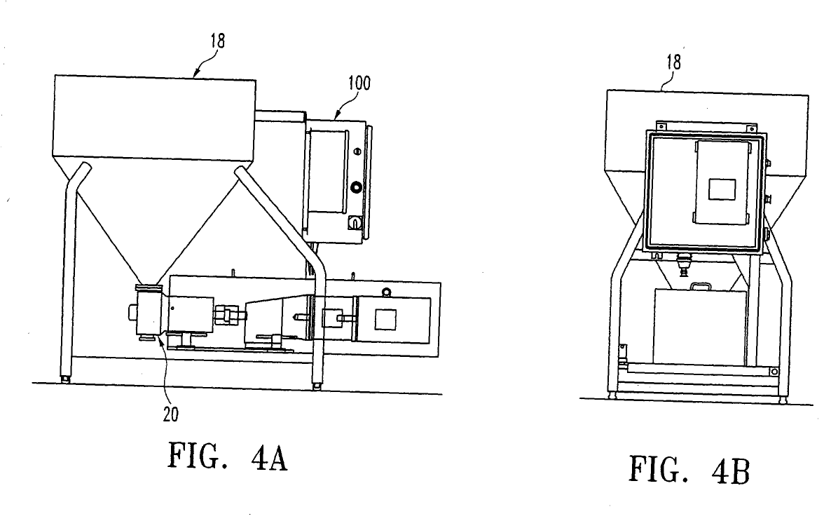

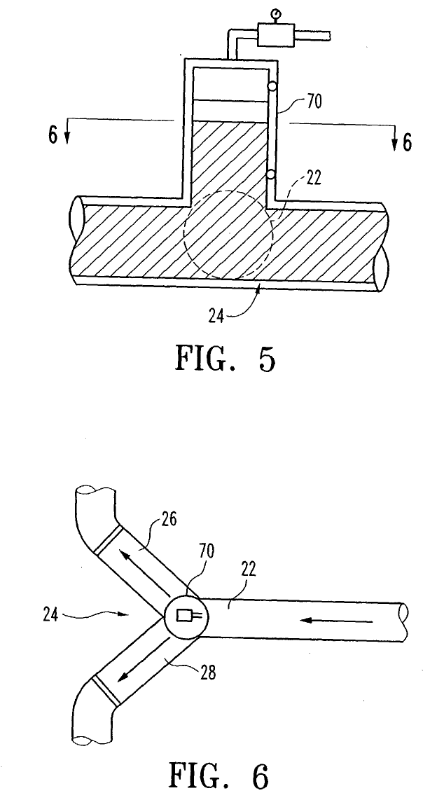

With reference to FIG. 3, the essential structure of FIG. 3 is virtually identical to that of FIG. 2 except that the sausage machines 10 and 12 in FIG. 3 are mirror images thereof so as to create work stations 60 and 64 on the inward sides of machines 10 and 12 and directly within the space 14. Operators 60A and 64A occupy the work stations 60 and 64, respectively, to operate the machines 10 and 12. Also, work stations 62 and 66 and located within the space 34. The operator (or robot) 36A occupies the same work station space in FIG. 3 as in FIG. 2, and that person is able to stick off the encased sausage strands from each conveyor 30 and 32. With reference to both FIGS. 2, 3, 5 and 6, an electronic sensor 70 is located within first conduit 22. The sensor 70 is a pressure sensitive sensor which is electronically connected to a control 100 (FIG. 4) which in turn is connected to pump 20 so that if the pressure in conduit 22 decreases the computer will energize the pump 20 to maintain the pressure within conduit 22 and the conduits 26 and 28. In place of sensor 70, a conventional pneumatically controlled accumulator can be imposed alternately in conduit 22 to assure that the pressure of the meat emulsion in conduit 22 will always remain substantially constant.

It is therefore seen that this invention will accomplish at least all of its stated objectives.

What is claimed is:

1. A system for making encased sausages, comprising,
first and second or multiple sausage encasing and linking machines disposed in parallel spaced condition to create a first space therebetween, and each being connected to a single meat emulsion supply pump located upstream from the encasing and linking machines, a first conduit extending from the meat emulsion supply pump, second conduits extending from the first conduit to the respective encasing and linking machines, whereby meat emulsion can be simultaneously pumped from the supply pump to the encasing and linking machines, first and second conveyors disposed in parallel spaced condition to create a second space therebetween and being located downstream from the first and second encasing and linking machines respectively, with the second space being coextensive with the first space to permit a work station for an operator to remove encased sausages from both of the conveyors.

2. The system of claim 1 wherein the operator removing encased sausages from both of the conveyors is a robotic device.

3. The system of claim 1 wherein the first space is sufficiently large to provide a second work station to service the first and second encasing and linking machines.

4. The system of claim 1 wherein the first conduit extends longitudinally from a meat emulsion supply source to the sausage encasing and linking machines, and the second conduits are of substantially equal length as they extend from the first conduit to meat emulsion metering devices on the encasing and linking machines.

5. The system of claim 1 wherein a means are provided to measure meat pressure in the first conduit, and is electronically connected to a pressure control means on the supply pump to control pressure on the meat emulsion flowing from the supply pump into the first conduit.

6. The system of claim 5 wherein an air cylinder/piston type accumulator is imposed in the first conduit to stabilize pressure on the meat emulsion flowing from the pressure pump on the hopper into the second conduit.

7. The system of claim 1 wherein the first and second sausage encasing and linking machines are mirror images of each other.

8. The system of claim 1 wherein third and fourth spaces exist adjacent the encasing and linking machines on the side of the machine opposite the first space to provide work stations for additional operators or robots to operate the respective machines.

9. The system of claim 1 wherein at least one of the encasing and linking machines is adapted for filling sausage casing comprised of natural animal intestines.

10. The system of claim 1 wherein at least one of the encasing and linking machines is adapted for filling sausage casings which are comprised of artificial manufactured casing materials.

11. The system of claim 1 wherein one of the encasing and linking machines is adapted for filling sausage casing comprised of natural animal intestines, and the other machine is adapted to fill casings which are comprised of artificial manufactured casing materials.

12. The system of claim 1 wherein the first and second conveyors comprise a plurality of hooks on a continuous flexible member rotatable in a horizontal plane.

13. The system of claim 12 wherein power means are provided for selectively rotating hooks on the first and second conveyors in opposite directions.

14. A system for making encased sausages, comprising, first and second or multiple sausage encasing and linking machines disposed in parallel spaced condition to create a first space therebetween, a single meat emulsion supply pump located in the first space between the encasing and linking machines, an emulsion supply pump associated with a hopper and attached to a first conduit extending from the emulsion supply pump, second conduits extending from the first conduit to the respective sausage encasing and linking machines, whereby meat emulsion can be simultaneously pumped from the emulsion supply pump to the encasing and linking machines, first and second conveyors disposed in parallel spaced condition to create a second space therebetween and being located downstream from the first and second encasing and linking machines respectively, with the second space being coextensive with the first space to permit a work station for an operator or robotic device to remove encased sausages from both of the conveyors,
a transducer for measuring meat pressure is in the first conduit, and is electronically connected to a pressure control means on the emulsion supply pump to control pressure on the meat emulsion flowing from the pressure pump into the first conduit, and an air cylinder/piston type accumulation is imposed in the first conduit to stabilize pressure on the meat emulsion flowing from the pressure pump into the second conduit.

15. A method of making encased sausages, comprising, providing first and second sausage encasing and linking machines disposed in parallel spaced condition to create a first space therebetween, and each having a meat emulsion metering device located upstream of a sausage encasing and linking assembly, providing a single meat emulsion supply pump with associated hopper located in the first space between the encasing and linking machines, providing a first conduit extending from the pressure pump, providing second conduits extending from the first conduit to respective metering devices upon the encasing and linking machines, whereby meat emulsion can be simultaneously pumped from the meat emulsion supply pump to the encasing and linking machines, and providing first and second conveyors disposed in parallel spaced condition to create a second space therebetween and located downstream from the first and second or multiple encasing and linking machines respectively, with the second space being coextensive with the first space to permit a work station for an operator or robot to remove encased sausages from both of the conveyors.

16. The system of claim 4 wherein an air cylinder/piston type accumulator is imposed in the first conduit to stabilize pressure on the meat emulsion flowing from the pressure pump on the hopper into the second conduit.
